(19) United States
(12) Patent Application Publication
(10) Pub. No.: US 2026/0092669 A1
(43) Pub. Date: Apr. 2, 2026

(54) MAGNETIC STAND AND GIMBAL

(71) Applicant: ARASHI VISION INC., Shenzhen (CN)

(72) Inventor: Yanwen MA, Shenzhen (CN)

(73) Assignee: ARASHI VISION INC., Shenzhen (CN)

(21) Appl. No.: 19/342,553

(22) Filed: Sep. 27, 2025

(30) Foreign Application Priority Data
Sep. 29, 2024 (CN) 202422410905.8

(51) Int. Cl. F16M 11/04; F16M 11/10

(52) U.S. Cl. CPC F16M 11/041; F16M 11/10

(57) ABSTRACT

The present disclosure relates to a magnetic stand and a gimbal. The magnetic stand includes a body and a support ring. The body has opposing first side wall and second side wall. The first side wall is magnetically connected to an imaging device. The support ring is rotatably connected to the second side wall and can move relative to the body, so that the support ring can switch between a retracted state and an expanded state. When the support ring is in the retracted state, the second side wall is magnetically connected to the gimbal. When the support ring is in the expanded state, the second side wall and the support ring form a stand to support the imaging device on a support surface.

### CROSS-REFERENCE TO RELATED APPLICATION

This application claims the benefit of priority to Chinese Patent Application No. 202422410905.8, filed on September 29, 2024, the entire content of which is hereby incorporated by reference in its entirety.

### TECHNICAL FIELD

The present disclosure relates to the technical field of mounting equipment, and particularly relates to a magnetic stand and a gimbal.

### BACKGROUND

Currently, when it is necessary to connect an imaging device to a stabilizing device, a magnetic clamping stand is typically used to magnetically attach the two devices. However, in the related art, the clamping stand can only be used for magnetic connection between the imaging device and the stabilizing device. When it is not necessary to connect the imaging device to the stabilizing device, for example, when the user wants to support the imaging device on a surface such as a desktop, the magnetic stand fails to provide support, resulting in poor practicality and inconvenience.

### SUMMARY

To address the issues in the related art, the present disclosure provides a magnetic stand and a gimbal.

According to a first aspect of the implementations of the present disclosure, a magnetic stand is provided, including: a body, including a first portion and a second portion connected to one another, the body having opposing first and second side walls; and a circular groove disposed at a junction of the first and second portions; a first magnet assembly, including a first magnet and a second magnet, the first magnet being a notched ring and including an annular portion and a notch portion, the circular groove being positioned at least partially in the notch portion, the first magnet being positioned in the first portion, the second magnet being positioned in the second portion, and the first magnet assembly being configured to magnetically connect to the imaging device; a second magnet assembly, including a third magnet positioned in the first portion, the first magnet surrounding the third magnet, and the second magnet assembly being configured to magnetically connect to the gimbal; and a support ring rotatably connected to the body through the circular groove, the support ring being switchable between an expanded state and a retracted state, and in the retracted state, the imaging device being connected to the gimbal through the magnetic stand.

In one possible implementation, the first magnet includes a plurality of square magnets surrounding the first magnet to form the notched ring.

In one possible implementation, the first side wall is magnetically connected to the imaging device, and the second side wall is further provided with a positioning protrusion, the magnetic stand being positioned by latching engagement between the positioning protrusion and the gimbal.

In one possible implementation, the second side wall is provided with an accommodating portion configured to accommodate the support ring, the support ring being rotatably connected to the second side wall; and when the support ring is in the retracted state, the second side wall is magnetically connected to the gimbal to connect the imaging device to the gimbal.

In one possible implementation, the accommodating portion is positioned between the first magnet and the third magnet, and the support ring in the retracted state is positioned between the first magnet and the third magnet.

In one possible implementation, the body is provided with a third mounting groove for mounting the third magnet; and a center of the accommodating portion coincides with a center of the first magnet, and a center of the support ring in the retracted state coincides with a center of the first magnet; and/or a center of the accommodating portion coincides with a center of the third mounting groove, and a center of the support ring in the retracted state coincides with a center of the third mounting groove; and/or a center of the first magnet coincides with a center of the third mounting groove.

In one possible implementation, the magnetic stand further includes: a first rotation assembly and a second rotation assembly; the support ring rotates relative to the body through at least one of the first rotation assembly or the second rotation assembly, where: the first rotation assembly rotates around a first rotation axis relative to the body, and the second rotation assembly rotates around a second rotation axis relative to the body the first rotation axis is perpendicular to an axis of the third magnet; and the second rotation axis is parallel to the axis of the third magnet.

In one possible implementation, the support ring is connected to the second side wall through the second rotation assembly, the second rotation assembly including: a rotating base rotatably positioned at a side of the circular groove close to the second side wall; a first connecting piece positioned on a side of the circular groove close to the first side wall, the first connecting piece being provided with a plurality of rotation feedback points uniformly arranged along its circumference; and a second connecting piece positioned at a side of the first connecting piece close to the first side wall, the rotating base partially passing through the first connecting piece and being fixedly connected to the second connecting piece, the second connecting piece also being provided with one or more rotation limiting parts cooperating with the rotation feedback points.

In one possible implementation, the first connecting piece is annular, the first connecting piece is provided with a first mating part along the circumference, and the circular groove is provided with a second mating part adapted to the first mating part. When the first connecting piece is mounted in the circular groove, the first mating part engages with the second mating part to restrict relative rotation of the first connecting piece and the circular groove.

In one possible implementation, the rotating base is provided with a plurality of latching parts at a side close to the first side wall; the second connecting piece is provided with a plurality of latching mating parts, a number of the latching mating parts being equal to a number of the latching parts, and the latching parts passing through the first connecting piece and fixedly connecting with the latching mating parts to clamp and fix the first connecting piece; or the second rotation assembly further comprises a fastener, the second connecting piece being fixedly connected to the rotating base through the fastener.

According to a second aspect of the implementations of the present disclosure, a gimbal is provided, the gimbal including the magnetic stand as described in the first aspect of the implementations of the present disclosure.

The technical solutions provided by the implementations of the present disclosure can include the following beneficial effects: the magnetic stand of the present disclosure is provided with a support ring that can switch between a retracted state and an expanded state. When the support ring is in the retracted state, the magnetic stand can connect the shooting device to the gimbal. When the support ring is in the expanded state, the magnetic stand can independently support the shooting device, improving the practicality and convenience of the magnetic stand in supporting the shooting device and enhancing the user experience.

It should be understood that the above general description and the following detailed description are only exemplary and explanatory and do not limit the present disclosure.

### BRIEF DESCRIPTION OF DRAWINGS

The drawings herein are incorporated into and constitute a part of the specification, illustrate implementations consistent with the present disclosure, and together with the specification, serve to explain the principles of the present disclosure.

FIG. 1 is a front view showing a support ring in a retracted state according to some embodiments of the present disclosure.

FIG. 2 is a first rear view showing the support ring in the retracted state according to some embodiments of the present disclosure.

FIG. 3 is a second rear view showing the support ring in the retracted state according to some embodiments of the present disclosure.

FIG. 4 is a first structural schematic diagram showing the support ring in the retracted state according to some embodiments of the present disclosure.

FIG. 5 is a second structural schematic diagram showing the support ring in the retracted state according to some embodiments of the present disclosure.

FIG. 6 is a first structural schematic diagram showing the support ring in an expanded state according to some embodiments of the present disclosure.

FIG. 7 is a second structural schematic diagram showing the support ring in the expanded state according to some embodiments of the present disclosure.

FIG. 8 is a first exploded view of a magnetic bracket according to some embodiments of the present disclosure.

FIG. 9 is a second exploded view of the magnetic bracket according to some embodiments of the present disclosure.

### DETAILED DESCRIPTION

The exemplary implementations will be described in detail herein, with examples illustrated in the drawings. In the following description, when referring to the drawings, unless otherwise indicated, the same numerals in different drawings refer to the same or similar elements. The implementations described in the following exemplary implementations do not represent all implementations consistent with the present disclosure. On the contrary, they are merely examples of devices and methods consistent with some aspects of the present disclosure as detailed in the appended claims.

Currently, when it is necessary to connect an imaging device to a stabilizing device, a magnetic stand is typically used to magnetically attach the two devices together. However, in the related art, the magnetic stand can only be used for magnetic connection between the imaging device and the stabilizing device. When it is not necessary to connect the imaging device to the stabilizing device, for example, when the user wants to support the imaging device on a surface such as a desktop, the magnetic bracket cannot provide support, resulting in poor practicality and inconvenience.

To address the issue in the related art, the present disclosure provide a magnetic stand. A support ring that can be switchable between a retracted state and an expanded state is provided. When the support ring is in the retracted state, the magnetic stand can connect the imaging device to the gimbal. When the support ring is in the expanded state, the magnetic stand can independently support the imaging device. This configuration improves the practicality and convenience of the magnetic stand in supporting the imaging device and enhances the user experience.

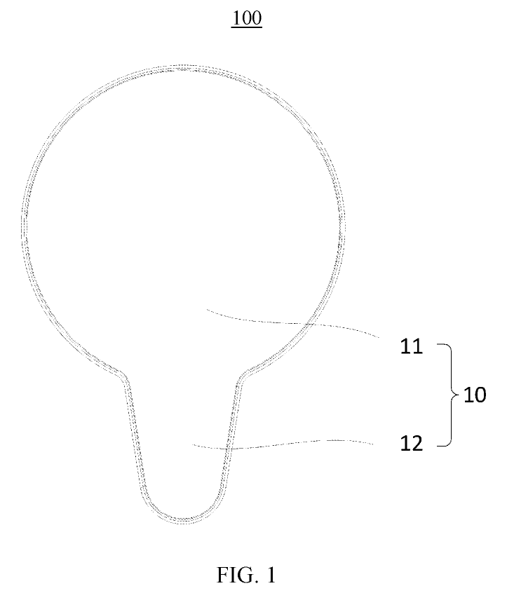

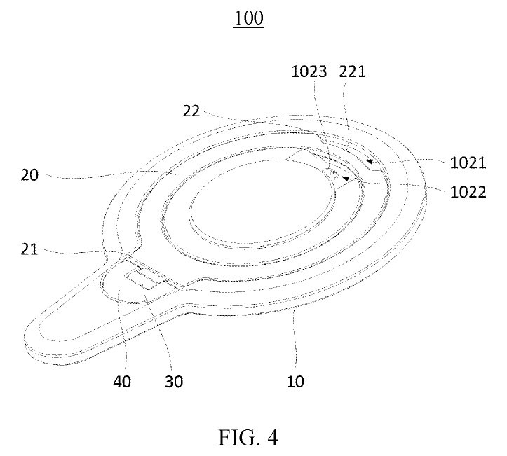

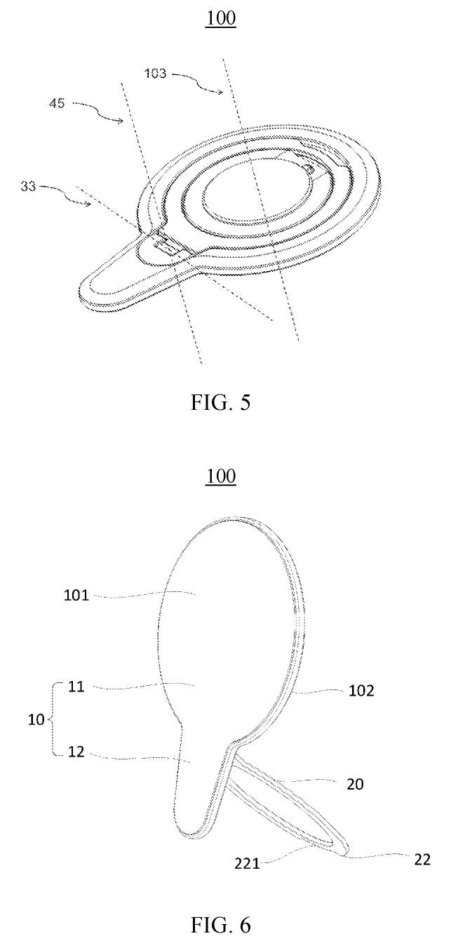

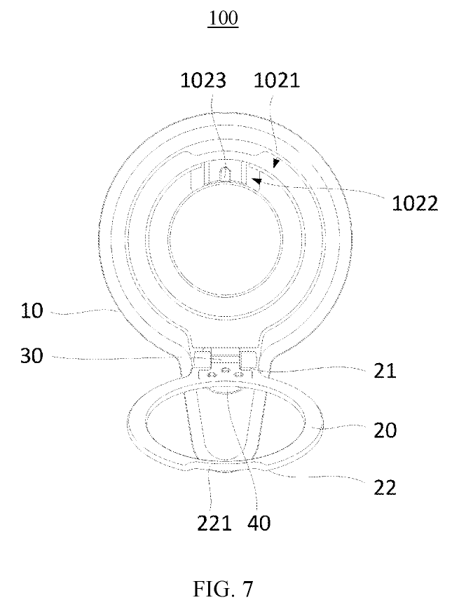

According to an exemplary implementation, as shown in FIGS. 1 to 9, the present disclosure provide a magnetic stand 100. The magnetic stand 100 includes a body 10 and a support ring 20. The support ring 20 has a retracted state and an expanded state, and is switchable between the retracted state and the expanded state. As shown in FIGS. 1 to 4, the support ring 20 is in the retracted state. In this state, the magnetic stand 100 can be configured to magnetically connect an imaging device (not shown in the drawings) to a gimbal (not shown in the drawings). As shown in FIGS. 6 to 7, the support ring 20 is in the expanded state. In this state, the magnetic stand 100 can be configured to support the imaging device on a support surface (not shown in the drawings). The imaging device may be, for example, a mobile terminal, a tablet computer, a camera, or other electronic device with a shooting function. The support surface may be, for example, a desktop, countertop, or the like.

The body 10 has opposing first side wall 101 and second side wall 102. The first side wall 101 is used for magnetic connection with the imaging device. The first side wall 101 can be magnetically connected to the imaging device in various ways. In one example, the first side wall 101 can be magnetically connected to the metal back cover of the imaging device. In another example, the first side wall 101 can be magnetically connected to a magnetic sheet attached to the back cover of the imaging device. In yet another example, the first side wall 101 can be magnetically connected to a wireless charging magnet of the imaging device.

The support ring 20 is rotatably connected to the second side wall 102 and can move relative to the body 10. In some implementations, the support ring 20 may have a first end 21 and a second end 22, with the first end 21 and the second end 22 spaced apart from one another. The first end 21 of the support ring 20 is rotatably connected to the second side wall 102, and the second end 22 of the support ring 20 can move relative to the body 10, so that the support ring 20 can switch between the retracted state and the expanded state. When the support ring 20 is in the retracted state, the second side wall 102 can be magnetically connected to a stabilizing device such as a gimbal. When the support ring 20 is in the expanded state, the second side wall 102 and the support ring 20 form a stand to support the imaging device on a support surface.

In the present disclosure a support ring that can switch between a retracted state and an expanded state is provided. When the support ring is in the retracted state, the magnetic stand can connect the imaging device to the gimbal. When the support ring is in the expanded state, the magnetic stand can independently support the imaging device. This improves the practicality and convenience of the magnetic stand in supporting the imaging device and enhances the user experience.

In some implementations, the magnetic stand 100 includes a first rotation assembly 30 and/or a second rotation assembly 40. In one example, the magnetic stand 100 includes the first rotation assembly 30, and the support ring 20 is rotatably connected to the body 10 through the first rotation assembly 30, so that the support ring 20 can switch between the retracted state and the expanded state. In another example, the magnetic stand 100 includes the second rotation assembly 40, and the support ring 20 is rotatably connected to the body 10 through the second rotation assembly 40 to adjust the orientation of the support ring 20. The rotation axis of the first rotation assembly 30 relative to the body 10 is perpendicular to the rotation axis of the second rotation assembly 40 relative to the body 10.

In yet another example, the magnetic stand includes both the first rotation assembly 30 and the second rotation assembly 40. The support ring 20 is rotatably connected to the second rotation assembly 40 through the first rotation assembly 30, and the second rotation assembly 40 is rotatably connected to the body 10. The first rotation assembly 30 and the second rotation assembly 40 enable the support ring 20 to rotate in different directions, for example, to rotationally open and close relative to the body 10, and to rotate at different angles relative to the direction perpendicular to the body 10, so as to adjust the support angle and direction of the support ring 20 and improve the flexibility of operation.

In some implementations, the magnetic stand 100 includes a first rotation assembly 30. As shown in FIGS. 1 to 9, the first rotation assembly 30 is connected to the body 10 and the support ring 20, and the support ring 20 is rotatably connected to the body 10 through the first rotation assembly 30. In some implementations, since a stop limit may be formed between the edge of the body 10 and the edge of the support ring 20, the opening and closing angle range between the support ring 20 and the body 10 can be set to about 0 to 114°. It is understood that this angle range can also be designed and adjusted by those skilled in the art according to actual needs, and the implementations of the present disclosure do not impose excessive limitations on this.

In one example, the first rotation assembly 30 includes a rotating shaft 31 and a rotating frame 32. As shown in FIGS. 1 to 9, the rotating shaft 31 is rotatably connected to the second side wall 102 of the body 10, and is rotatable around its own axis. The axis of the rotating shaft 31 is parallel to the surface of the second side wall 102. The rotating frame 32 includes a first connecting part 321 and a second connecting part 322 that are connected to one another. The first connecting part 321 is fixedly connected to the rotating shaft 31, for example, by being sleeved over the rotating shaft 31, or by an interference fit with the shaft 31, or other means. The second connecting part 322 is fixedly connected to the support ring 20. By rotating the rotating shaft 31, the rotating frame 32 is driven to rotate, so that the second end 22 of the support ring 20 can move relative to the body 10. That is, the support ring 20 can open and close relative to the body 10, thereby realizing the switching between the expanded state and the retracted state of the support ring 20.

It can be understood that, in the implementations of the present disclosure, the rotating frame 32 is fixed to the rotating shaft 31 as an example for illustration. In actual production and design, the rotating shaft 31 can also be fixed to the body 10, and the rotating frame 32 can rotate relative to the rotating shaft 31. The implementations of the present disclosure do not impose any particular limitations on the specific arrangement of the rotating shaft 31 and the rotating frame 32, as long as the rotating frame 32 can drive the support ring 20 to rotate so as to switch between the expanded state and the retracted state.

In some implementations, the magnetic stand 100 further includes a second rotation assembly 40. As shown in FIGS. 1 to 9, the second rotation assembly 40 is connected to the first connecting part 321 of the rotating frame 32. The rotating frame 32 is rotatably connected to the body 10 through the second rotation assembly 40, and the first rotation assembly 30 and the second rotation assembly 40 enable the support ring 20 to rotate in different directions. One of the first rotation assembly 30 and the second rotation assembly 40 can enable the support ring 20 to open and close relative to the body 10, and the other can enable the support ring 20 to rotate around a second rotation axis 45 that is perpendicular to the thickness direction 103 of the body 10. By providing the first rotation assembly 30 and the second rotation assembly 40, rotation, and opening and closing of the support ring 20 can be achieved, which facilitates adjustment of the support angle and direction, and improves the flexibility of the magnetic stand in supporting the imaging device. The rotation angle of the support ring 20 around the second rotation axis 45 is about 0 to 360°, which can be adjusted by the user according to usage needs.

In some implementations, the second rotation assembly 40 includes a rotating mounting groove 41, a rotating base 42, a first connecting piece 43, and a second connecting piece 44. The rotating mounting groove 41 is provided on the body 10 and passes through the body 10. In some implementations, the rotating mounting groove 41 is a circular groove. The projections of the rotating base 42 and the second connecting piece 44 on the second side wall 102 of the body 10 are both circular, so as to realize the rotation of the rotating base 42 relative to the rotating mounting groove 41. The rotating base 42 is rotatably connected in the rotating mounting groove 41, and rotates around its own axis. The axis of the rotating base 42 is perpendicular to the surface of the second side wall 102. Both ends of the rotating shaft 31 are rotatably connected to the rotating base 42, so that the rotating shaft 31 can drive the support ring 20 to rotate around the axis of the rotating shaft 31. That is, the support ring 20 can open and close relative to the body 10. The rotating base 42 can drive the rotating shaft 31 to rotate around the axis of the rotating base 42, thereby driving the support ring 20 to rotate relative to the body 10.

The first connecting piece 43 is provided on the side of the rotating mounting groove 41 away from the first rotation assembly 30, and is fixedly connected to the rotating mounting groove 41. The second connecting piece 44 is provided on the side of the first connecting piece 43 away from the first rotation assembly 30. A portion of the rotating base 42 passes through the first connecting piece 43, and is fixedly connected to the second connecting piece 44. The second connecting piece 44 is also rotatably connected to the first connecting piece 43. The second connecting piece 44 is configured to rotatably connect the rotating base 42 to the first connecting piece 43, and the first connecting piece 43 is fixedly connected to the rotating mounting groove 41, so that the rotating base 42 is rotatably connected to the rotating mounting groove 41.

It is understood that when the second connecting piece 44 is fixedly connected to the rotating base 42, a portion of the second connecting piece 44 can also pass through the first connecting piece 43, and be fixedly connected to the rotating base 42. Multiple latching parts and multiple latching mating parts can be respectively provided on the second connecting piece 44 and the rotating base 42, or the second connecting piece 44 and the rotating base 42 can be connected by a fastener to improve the tightness of the connection between the second connecting piece 44 and the rotating base 42. The implementations of the present disclosure do not impose any particular limitations on the specific way of fixed connection between the second connecting piece 44 and the rotating base 42, and those skilled in the art can set it according to actual needs.

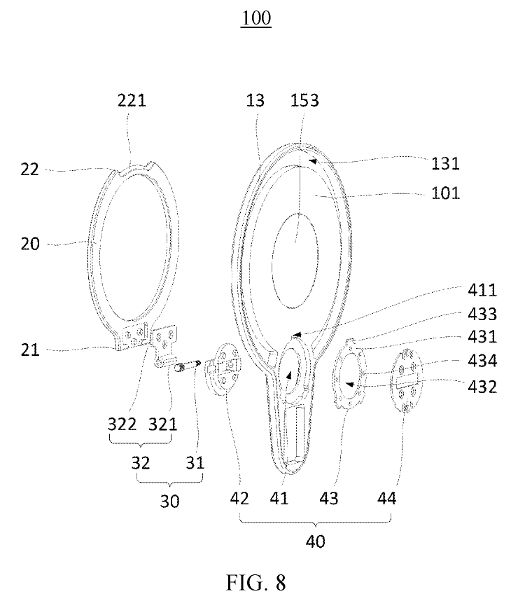

In one example, as shown in FIG. 8, the first connecting piece 43 includes a connecting body 431, which has a hollow structure. In some implementations, the connecting body 431 is annular, and the center of the connecting body 431 has a mounting space 432. A portion of the second connecting piece 44 passes through the mounting space 432 and is fixedly connected to the rotating base 42, or a part of the rotating base 42 passes through the mounting space 432 and is fixedly connected to the second connecting piece 44, so as to rotatably connect the rotating base 42 to the first connecting piece 43.

The edge of the connecting body 431 is provided with a plurality of first mating parts 433, which are evenly arranged along the circumference of the connecting body 431. The rotating mounting groove 41 is provided with a plurality of second mating parts 411 that mate with the plurality of first mating parts 433. One of the first mating part 433 and the corresponding second mating part 411 is a slot, and the other is a block, so as to latch the connecting body 431 and the rotating mounting groove 41 together. It is understood that the first mating parts 433 and the second mating parts 411 can also use other connection methods, such as connection by fasteners, bonding, welding, etc. The number and arrangement of the first mating parts 433 can also be set by those skilled in the art according to actual needs, and the implementations of the present disclosure do not impose special limitations on this.

In one example, the first connecting piece 43 is further provided with a plurality of rotation feedback points 434 evenly arranged along its circumference. As shown in FIG. 8, the rotation feedback points 434 are provided on the connecting body 431. In the implementations of the present disclosure, the first connecting piece 43 is provided with eight rotation feedback points 434, i.e., every 45° of rotation passes through a rotation feedback point 434. When passing through a rotation feedback point 434, a slight resistance occurs during the rotation to provide tactile feedback, or, when passing through a rotation feedback point 434, the rotation base 42 can be stopped at that position through a limiting fit at the rotation feedback point 434 to realize indexed rotational adjustment. It can be understood that, in actual design and production, the number of rotation feedback points 434 can be increased or decreased, and the implementations of the present disclosure do not impose special limitations on this and can be set by those skilled in the art according to actual needs.

The rotation feedback points 434 can be provided on the side of the first connecting piece 43 close to the rotating base 42, or on the side of the first connecting piece 43 close to the second connecting piece 44. When the rotation feedback points 434 are provided on the side close to the rotating base 42, the rotating base 42 close to the first connecting piece 43 can be provided with a rotation limiting part (not shown in the drawings). The rotation limiting part cooperates with the rotation feedback points 434 to restrict the rotation of the rotating base 42 at different angles, realizing adjustment of different indexed rotational positions. One of the rotation limiting part and the rotation feedback points 434 is a slot, and the other is a block, and the rotation angle of the rotating base 42 is limited by latching cooperation. When the rotation feedback points 434 are provided on the side close to the second connecting piece 44, the second connecting piece 44 close to the first connecting piece 43 can be provided with a rotation limiting part, and the way of latching cooperation between the rotation limiting part and the rotation feedback points 434 is the same as described above and will not be repeated here.

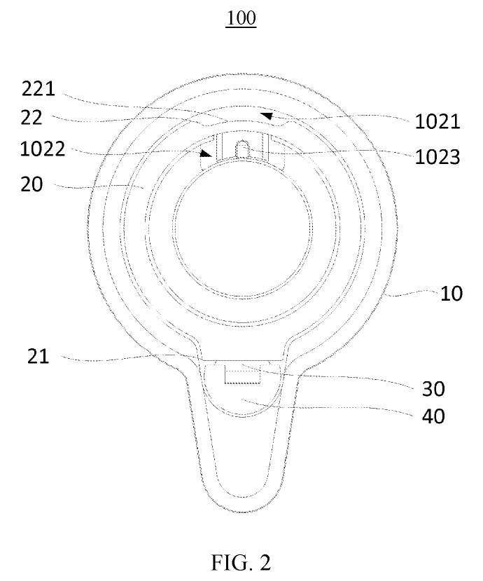

In some implementations, the second side wall 102 of the body 10 is provided with an accommodating portion 1021 for accommodating the support ring 20. As shown in FIGS. 2 to 7, the accommodating portion 1021 is an annular groove. When the support ring 20 is in the retracted state, the support ring 20 is accommodated in the accommodating portion 1021 to prevent the support ring 20 from protruding from the second side wall 102 of the body 10, facilitating magnetic connection between the body 10 and the stabilizing device.

In one example, the second end 22 of the support ring 20 is provided with an avoidance portion 221. A gap is formed between the avoidance portion 221 and the accommodating portion 1021, which facilitates the user to pull and unfold the support ring 20 from the position of the avoidance portion 221, and can also serve as an indication of the operation direction.

In one example, the accommodating portion 1021 is further provided with a positioning groove 1022, and a positioning protrusion 1023 is provided in the positioning groove 1022. The positioning protrusion 1023 is a protruding structure formed inside the positioning groove 1022. The positioning groove 1022 is configured for latching engagement and positioning with the stabilizing device. When the second side wall 102 is magnetically connected to the stabilizing device, a detection member (not shown in the drawings) of the stabilizing device cooperates with the positioning protrusion 1023 to detect the installation position of the magnetic stand. The detection member can be a switch, sensor, or other component. When the second side wall 102 is magnetically connected to the stabilizing device, the detection member detects the positioning protrusion 1023 in the positioning groove 1022 and provides tactile feedback, control circuit feedback, or other means to indicate whether the magnetic stand is properly installed on the stabilizing device.

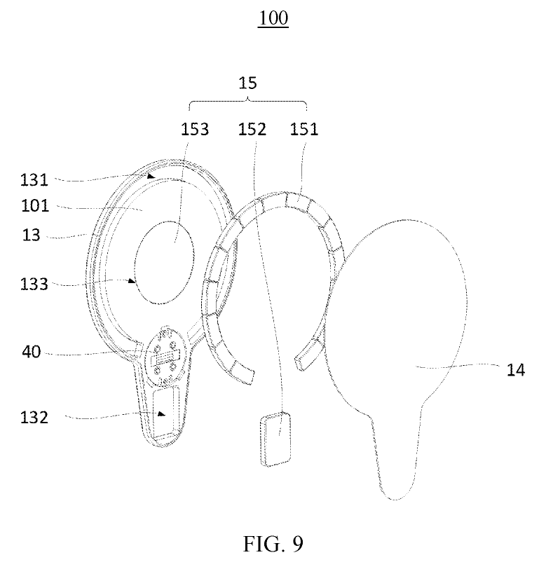

In some implementations, the body 10 includes a base 13, a cover plate 14, and a magnet assembly 15. As shown in FIG. 9, the cover plate 14 is provided on the first side wall 101 and is fixedly connected to the base 13. An accommodating space is formed between the base 13 and the cover plate 14. The magnet assembly 15 is provided in the accommodating space between the base 13 and the cover plate 14 for realizing magnetic connection.

In some implementations, the magnet assembly 15 includes a first magnet assembly and a second magnet assembly. The first magnet assembly is configured to provide magnetic connection between the imaging device and the magnetic stand, and the second magnet assembly is configured to provide magnetic connection between the magnetic stand and the stabilizing device.

In some implementations, the body 10 includes connected first portion 11 and second portion 12. As shown in FIGS. 1 to 9, the first rotation assembly 30, the second rotation assembly 40, and the rotating mounting groove 41 are all located at the junction of the first portion 11 and the second portion 12.

In some implementations, the first magnet assembly includes a first magnet 151 and a second magnet 152. As shown in FIGS. 1 to 9, the first magnet 151 is located at the first portion 11, and the second magnet 152 is located at the second portion 12. In some implementations, the first magnet 151 is an annular magnet, and the second magnet 152 is a square magnet. The first magnet assembly can be magnetically connected to a wireless charging magnet (not shown in the drawings) of the imaging device. The wireless charging magnet usually includes an annular main body, and a tail provided at one end of the main body. The first magnet 151 corresponds to the main body of the wireless charging magnet, and the second magnet 152 corresponds to the tail of the wireless charging magnet. It should be noted that the first magnet can also be an incomplete annular magnet with a notch, and the rotating mounting groove 41 can be provided at the notch to achieve an overall compact structure of the magnetic stand 100.

In some implementations, the second magnet assembly includes a third magnet 153. As shown in FIGS. 1 to 9, the third magnet 153 is provided at the first portion 11, and the first magnet 151 surrounds the third magnet 153. The third magnet 153 is configured to provide magnetic connection with the stabilizing device, so that the magnetic stand 100 can be connected to the stabilizing device.

In some implementations, the accommodating space of the base 13 is provided with a mounting groove for mounting the magnet assembly 15. The shape of the mounting groove matches the shape of the magnet assembly 15. When the magnet assembly 15 is mounted in the mounting groove, the axial direction of the magnet assembly 15 is the thickness direction 103 of the body 10 or is parallel to the thickness direction 103 of the body 10. As shown in FIG. 9, the base 13 is provided with a first mounting groove 131, a second mounting groove 132, and a third mounting groove 133. The first mounting groove 131 is configured to mount the first magnet 151, the second mounting groove 132 is configured to mount the second magnet 152, and the third mounting groove 133 is configured to mounting the third magnet 153. It should be noted that the accommodating portion 1021 is essentially an accommodating groove for accommodating the support ring 20. The accommodating portion 1021 is provided at one side of the base 13, while the first mounting groove 131, the second mounting groove 132, and the third mounting groove 133 are provided at the other side of the base 13. Structurally, the accommodating portion 1021 is located between the first mounting groove 131 and the third mounting groove 133. That is, when the support ring 20 is accommodated in the accommodating portion 1021, the support ring 20 is also located between the first mounting groove 131 and the third mounting groove 133.

It is understood that the number and shape of the magnets in the magnet assembly 15 can be adjusted by those skilled in the art according to actual needs. Each magnet can also be mounted on the base 13 by bonding, fastener connection, or other means. The implementations of the present disclosure do not impose excessive limitations on this.

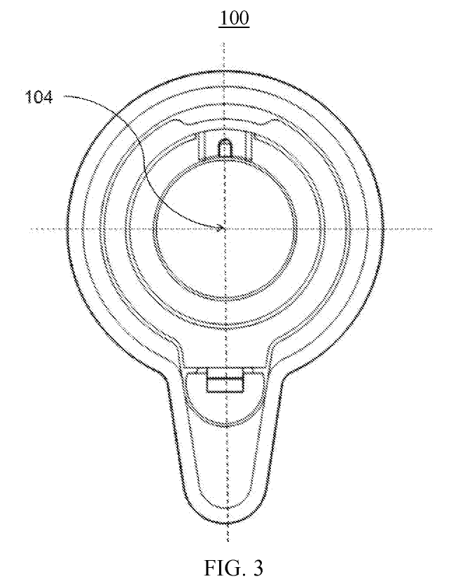

In some implementations, the first mounting groove 131, the third mounting groove 133, and the accommodating portion 1021 are designed to be concentric, i.e., their geometric centers coincide. For example, when the first mounting groove 131, the third mounting groove 133, and the accommodating portion 1021 are all circular, their centers coincide, as shown by the center point 104 in FIG. 3. Alternatively, when one or more of the first mounting groove 131, the third mounting groove 133, and the accommodating portion 1021 are polygons such as equilateral triangles or squares, their geometric centers also coincide. It should be understood that when the first magnet 151 and the third magnet 153 are mounted in the first mounting groove 131 and the third mounting groove 133 respectively, due to the shape matching, the first magnet 151 and the third magnet 153 are also concentric with the accommodating portion 1021, and the axial direction of the first magnet 151 and the third magnet 153 is the thickness direction 103 of the body 10. The implementations of the present disclosure do not impose excessive limitations on the shapes of the first mounting groove 131, the third mounting groove 133, and the accommodating portion 1021.

In some implementations, different parts of the magnetic stand 100 use different materials and/or are processed with different techniques. The various parts of the magnetic stand 100 can be assembled by bonding, latching, fastener connection, or other means. The implementations of the present disclosure do not impose excessive limitations on this.

The base 13, the support ring 20, the rotating shaft 31, the rotating frame 32, the rotating base 42, the first connecting piece 43, and the second connecting piece 44 can be made of metal or alloy materials to ensure sufficient rigidity and strength, and guarantee reliable support. In some implementations, the base 13, the support ring 20, and the rotating base 42 can be made of AL6061 aluminum alloy, and the surface can be treated with sandblasting and anodizing to improve wear resistance, corrosion resistance, heat resistance, hardness, and other mechanical properties. Laser engraving can also be configured to print patterns on the surface of the base 13 to improve aesthetics. The rotating shaft 31 can be made of 1144 medium carbon free-cutting steel, which has the advantages of high purity, excellent material, and stable processing. The surface can also be treated with natural purification to form a protective film, thereby improving wear and corrosion resistance. The rotating frame 32, the first connecting piece 43, and the second connecting piece 44 can be made of ASE1085 carbon steel, and natural purification and heat treatment can be provided to improve wear resistance, corrosion resistance, hardness, and other mechanical properties.

The first magnet assembly can use N52 magnets and SPCC cold-rolled carbon steel, and nickel plating and zinc plating can be used to form chemically stable nickel and zinc layers on the surface. The second magnet assembly can use N52 magnets, and nickel plating can be used to improve corrosion resistance.

The cover plate 14 can be made of silicone, and patterns or designs can be printed on the cover plate 14 by screen printing to improve aesthetics.

It is understood that the specific materials and processing techniques used for the various parts of the magnetic stand are not limited to those listed in the implementations of the present disclosure. Those skilled in the art can select them according to actual needs.

According to an exemplary implementation, still referring to FIGS. 1 to 9, the implementations of the present disclosure provide a gimbal (not shown in the drawings). The gimbal is configured to mount and support an imaging device (not shown in the drawings) to ensure imaging stability and thereby improve the clarity of the captured image. The gimbal includes the magnetic stand 100 as described in the above implementations. The magnetic stand includes a body 10 and a support ring 20. The support ring 20 has a retracted state and an expanded state. The support ring 20 is rotatably connected to the second side wall 102 and can move relative to the body 10, so that the support ring 20 can switch between the retracted state and the expanded state. When the support ring 20 is in the retracted state, the magnetic stand can magnetically connect the imaging device to the gimbal. When the support ring 20 is in the expanded state, the magnetic stand 100 can be used to support the imaging device on a support surface.

Those skilled in the art, after considering the specification and practicing the disclosure disclosed herein, will readily think of other implementations of the present disclosure. The present disclosure is intended to cover any modifications, uses, or adaptations that follow the general principles of the present disclosure and include well-known or conventional techniques in the art that are not disclosed herein. The specification and implementations are to be regarded as exemplary only, and the true scope and spirit of the present disclosure are indicated by the following claims.

It should be understood that the present disclosure is not limited to the precise structure described above and shown in the drawings, and various modifications and changes can be made without departing from its scope. The scope of the present disclosure is limited only by the appended claims.

WHAT IS CLAIMED IS:

1. A magnetic stand for connecting an imaging device to a gimbal, comprising:
a body, comprising a first portion and a second portion connected to one another, the body having opposing first and second side walls;
a circular groove disposed at a junction of the first and second portions;
a first magnet assembly, comprising a first magnet and a second magnet, the first magnet being a notched ring and including an annular portion and a notch portion, the circular groove being positioned at least partially in the notch portion, the first magnet being positioned in the first portion, the second magnet being positioned in the second portion, and the first magnet assembly being configured to magnetically connect to the imaging device;
a second magnet assembly, comprising a third magnet positioned in the first portion, the first magnet surrounding the third magnet, and the second magnet assembly being configured to magnetically connect to the gimbal; and
a support ring rotatably connected to the body through the circular groove, the support ring being switchable between an expanded state and a retracted state, and in the retracted state, the imaging device being connected to the gimbal through the magnetic stand.

2. The magnetic stand according to claim 1, wherein the first magnet includes a plurality of square magnets surrounding the first magnet to form the notched ring.

3. The magnetic stand according to claim 1, wherein the first side wall is magnetically connected to the imaging device, and the second side wall is further provided with a positioning protrusion, the magnetic stand being positioned by latching engagement between the positioning protrusion and the gimbal.

4. The magnetic stand according to claim 1, wherein the second side wall is provided with an accommodating portion configured to accommodate the support ring, the support ring being rotatably connected to the second side wall; and
wherein, when the support ring is in the retracted state, the second side wall is magnetically connected to the gimbal to connect the imaging device to the gimbal.

5. The magnetic stand according to claim 4, wherein the accommodating portion is positioned between the first magnet and the third magnet, and the support ring in the retracted state is positioned between the first magnet and the third magnet.

6. The magnetic stand according to claim 4, wherein the body is provided with a third mounting groove for mounting the third magnet; and
wherein a center of the accommodating portion coincides with a center of the first magnet, and a center of the support ring in the retracted state coincides with a center of the first magnet; and/or
wherein a center of the accommodating portion coincides with a center of the third mounting groove, and a center of the support ring in the retracted state coincides with a center of the third mounting groove; and/or
wherein a center of the first magnet coincides with a center of the third mounting groove.

7. The magnetic stand according to claim 1, further comprising:
a first rotation assembly and a second rotation assembly,
wherein the support ring rotates relative to the body through at least one of the first rotation assembly or the second rotation assembly;
wherein the first rotation assembly rotates around a first rotation axis relative to the body, and the second rotation assembly rotates around a second rotation axis relative to the body;
wherein the first rotation axis is perpendicular to an axis of the third magnet; and
wherein the second rotation axis is parallel to the axis of the third magnet.

8. The magnetic stand according to claim 7, wherein the support ring is connected to the second side wall through the second rotation assembly, the second rotation assembly comprising:
a rotating base rotatably positioned at a side of the circular groove close to the second side wall;
a first connecting piece positioned on a side of the circular groove close to the first side wall, the first connecting piece being provided with a plurality of rotation feedback points uniformly arranged along its circumference; and
a second connecting piece positioned at a side of the first connecting piece close to the first side wall, the rotating base partially passing through the first connecting piece and being fixedly connected to the second connecting piece, the second connecting piece also being provided with one or more rotation limiting parts cooperating with the rotation feedback points.

9. The magnetic stand according to claim 8, wherein the first connecting piece is annular, the first connecting piece is provided with a first mating part along the circumference, and the circular groove is provided with a second mating part adapted to the first mating part; and
wherein, when the first connecting piece is mounted in the circular groove, the first mating part engages with the second mating part to restrict relative rotation of the first connecting piece and the circular groove.

10. The magnetic stand according to claim 8, wherein the rotating base is provided with a plurality of latching parts at a side close to the first side wall; and
wherein the second connecting piece is provided with a plurality of latching mating parts, a number of the latching mating parts being equal to a number of the latching parts, and the latching parts passing through the first connecting piece and fixedly connecting with the latching mating parts to clamp and fix the first connecting piece; or
wherein the second rotation assembly further comprises a fastener, the second connecting piece being fixedly connected to the rotating base through the fastener.

11. A gimbal, comprising a magnetic stand, wherein a shooting device is connected to the gimbal through the magnetic stand, and the magnetic stand comprises:
a body, comprising a first portion and a second portion connected to one another, and the body having with opposing first and second side walls;
a circular groove disposed at a junction of the first and second portions;
a first magnet assembly comprising a first magnet and a second magnet, the first magnet being a notched ring and including an annular portion and a notch portion, the circular groove being positioned at least partially in the notch portion, the first magnet being positioned in the first portion, the second magnet being positioned in the second portion, and the first magnet assembly being configured to magnetically connect to an imaging device;
a second magnet assembly, comprising a third magnet positioned in the first portion, the first magnet surrounding the third magnet, and the second magnet assembly being configured to magnetically connect to the gimbal; and
a support ring rotatably connected to the body through the circular groove, the support ring being switchable between an expanded state and a retracted state, and in the retracted state, the imaging device being connected to the gimbal through the magnetic stand.

12. The gimbal according to claim 11, wherein the first magnet includes a plurality of square magnets surrounding the first magnet to form the notched ring.

13. The gimbal according to claim 11, wherein the first side wall is magnetically connected to the imaging device, and the second side wall is further provided with a positioning protrusion, the magnetic stand being positioned by latching engagement between the positioning protrusion and the gimbal.

14. The gimbal according to claim 11, wherein the second side wall is provided with an accommodating portion configured to accommodate the support ring, and the support ring being rotatably connected to the second side wall; and
wherein, when the support ring is in the retracted state, the second side wall is magnetically connected to the gimbal to connect the imaging device to the gimbal.

15. The gimbal according to claim 14, wherein the accommodating portion is positioned between the first magnet and the third magnet, and the support ring in the retracted state is positioned between the first magnet and the third magnet.

16. The gimbal according to claim 14, wherein the body is provided with a third mounting groove for mounting the third magnet; and
wherein a center of the accommodating portion coincides with a center of the first magnet, and a center of the support ring in the retracted state coincides with a center of the first magnet; and/or
wherein a center of the accommodating portion coincides with a center of the third mounting groove, and a center of the support ring in the retracted state coincides with a center of the third mounting groove; and/or
wherein a center of the first magnet coincides with a center of the third mounting groove.

17. The gimbal according to claim 11, wherein the magnetic stand further comprises:
a first rotation assembly and a second rotation assembly,
wherein the support ring rotates relative to the body through at least one of the first rotation assembly or the second rotation assembly;
wherein a rotation axis of the first rotation assembly is perpendicular to an axis of the third magnet; and
wherein a rotation axis of the second rotation assembly is parallel to the axis of the third magnet.

18. The gimbal according to claim 17, wherein the support ring is connected to the second side wall through the second rotation assembly, the second rotation assembly comprising:
a rotating base rotatably positioned at a side of the circular groove close to the second side wall;
a first connecting piece positioned at a side of the circular groove close to the first side wall, and the first connecting piece being provided with a plurality of rotation feedback points uniformly arranged along its circumference; and
a second connecting piece positioned on a side of the first connecting piece close to the first side wall, the rotating base partially passing through the first connecting piece and being fixedly connected to the second connecting piece, the second connecting piece also being provided with one or more rotation limiting parts cooperating with the rotation feedback points.

19. The gimbal according to claim 18, wherein the first connecting piece is annular, the first connecting piece is provided with a first mating part along the circumference, and the circular groove is provided with a second mating part adapted to the first mating part; and
wherein when the first connecting piece is mounted in the circular groove, the first mating part engages with the second mating part to restrict relative rotation of the first connecting piece and the circular groove.

20. The gimbal according to claim 18, wherein the rotating base is provided with a plurality of latching parts at a side close to the first side wall; and
wherein the second connecting piece is provided with a plurality of latching mating parts, a number of the latching mating parts being equal to a number of the latching parts, and the latching parts passing through the first connecting piece and fixedly connecting with the latching mating parts to clamp and fix the first connecting piece; or
wherein the second rotation assembly further comprises a fastener, the second connecting piece being fixedly connected to the rotating base through the fastener.
